(19) United States
(12) Patent Application Publication
(10) Pub. No.: US 2023/0126736 A1
(43) Pub. Date: Apr. 27, 2023

(54) Actively Selecting of Power Supply Unit Operating Mode

(71) Applicant: Dell Products L.P., Round Rock, TX (US)

(72) Inventors: Ravi Shekhar Singh, Bangalore (IN); Vaishnavi S, Bangalore (IN)

(73) Assignee: Dell Products L.P., Round Rock, TX (US)

(21) Appl. No.: 17/509,538

(22) Filed: Oct. 25, 2021

(51) Int. Cl. G06F 1/3206

(52) U.S. Cl. CPC G06F 1/3206

(57) ABSTRACT

A power management system in an information handling system includes multiple power supply units (PSU). A PSU is designated as a rapid on active PSU. Efficiencies on operating voltage and load of the information handling system in regard to the rapid on active PSU are gathered. Maximum efficiency value and minimum efficiency value of the rapid on active PSU are determined and used to turn on and off one or more PSUs designated as ability to sleep when the maximum efficiency value is reached and turning off the one or more PSUs designated as ability to sleep based on the minimum efficiency value.

### BACKGROUND OF THE INVENTION

### Field of the Invention

The present invention relates to information handling systems. More specifically, embodiments of the invention provide for providing an active approach of selecting power supply unit operating mode.

### Description of the Related Art

As the value and use of information continues to increase, individuals and businesses seek additional ways to process and store information. One option available to users is information handling systems. Information handling systems include personal computers (PC), server computers, such as desktops. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, such as server computers and desktop computers rely on regulated power supplies or power supply units (PSU), to provide operating power. Implementations can provide for two PSUs where one or both may actively provide power to the information handling systems. One PSU can be active, while the other PSU is inactive or placed in sleep unit.

The active PSU can support 100 percent of the load of an information handling system, if such an operation provides a higher efficiency. The inactive or sleep state PSU can monitor output voltage of the active PSU. If the output voltage of the active PSU drops, the inactive or sleep state PSU can be placed in an active output state. If having both PSUs active is more efficient than having one PSU in the sleep state, the active PSU can activate the sleeping PSU. This process can be considered as “rapid on.”

It is desirable to determine when to activate/deactivate the inactive or sleep state PSU to achieve maximum efficiency. In other words, at what load on the active PSU based on percentage of PSU rated power wattage, should the inactive or sleep state PSU be switched to active state. Furthermore, a determination should be made as to what load on the active PSU based on percentage of PSU rated power wattage, should the inactive or sleep state PSU be placed in sleep state.

Different PSUs can have different efficiency curves for various loads. Also, the same PSU operating at different voltages (e.g., 110V and 230V) can have different efficiency response to load. Therefore, consideration is needed to properly use “rapid on” to provide efficient power consumption by the information handling system.

### SUMMARY OF THE INVENTION

A computer-implementable method, system and non-transitory, computer-readable storage medium for active selecting power supply unit operating mode comprising: determining power supply units (PSU) in an information handling system; designating one of the PSU as a rapid on active PSU; gathering efficiencies of the rapid on active PSU based on operating voltage and load of the information handling system; determining maximum efficiency value and minimum efficiency value of the rapid on active PSU based on the gathered efficiencies; turning on one or more PSUs designated as ability to sleep when the maximum efficiency value is reached; and turning off the one or more PSUs designated as ability to sleep based on the minimum efficiency value.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 illustrates a system that provides for an active approach of selecting power supply unit operating mode;

FIG. 3 illustrates a power supply unit efficiency table;

FIG. 4 illustrates power supply unit efficiency graphs;

FIG. 5 is a generalized flowchart for determining spare enabling and disabling points of power supply units;

FIG. 6 is a generalized flowchart for monitoring enabling points of power supply units;

FIG. 7 is a generalized flowchart for monitoring disabling points of power supply units; and

FIG. 8 is a generalized flowchart for an adaptive rapid on awake and sleep for an inactive or sleep state power supply unit.

### DETAILED DESCRIPTION

Various implementations provide for a system, method, and computer readable medium to use an adaptive rapid on awake and sleep for an inactive or sleep state power supply unit (PSU), which is based on efficiency response for various loads, capacity, and operating voltage of an active PSU.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

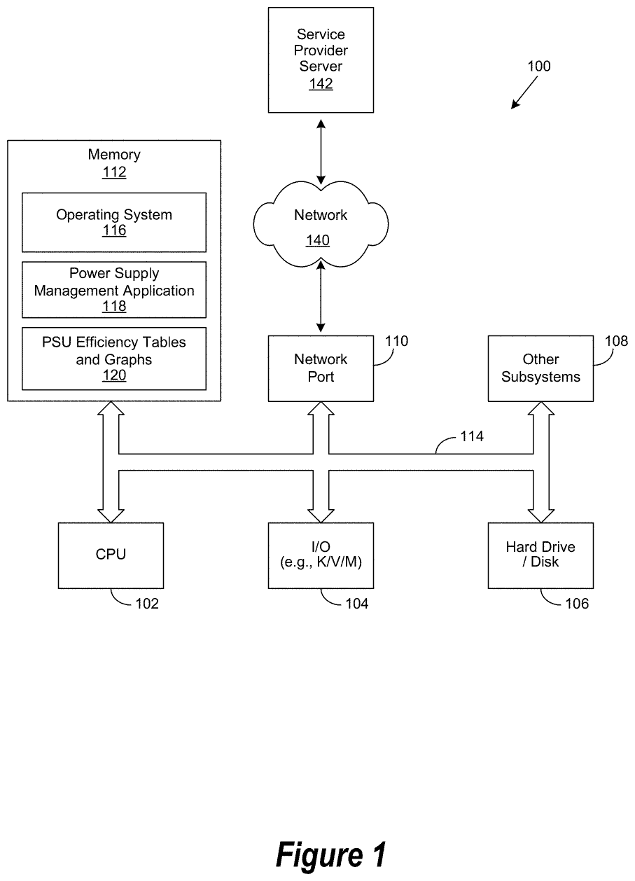

FIG. 1 is a generalized illustration of an information handling system 100 that can be used to implement the system and method of the present invention. The information handing system 100 can be a host to the peripheral devices described herein. As discussed, the information handling system can include a notebook or laptop personal computer (PC) or a PC integrated into a keyboard.

The information handling system 100 includes a processor (e.g., central processor unit or “CPU”) 102, input/output (I/O) devices 104, such as a microphone, a keyboard, a video/display, a mouse, and associated controllers (e.g., K/V/M), a hard drive or disk storage 106, and various other subsystems 108. In various embodiments, other subsystems 108 include power systems that include power supply units (PSUs) as described herein that provide operational power to the information handling system 100.

In various embodiments, the information handling system 100 also includes network port 110 operable to connect to a network 140, where network 140 can include one or more wired and wireless networks, including the Internet. Network 140 is likewise accessible by a service provider server 142. The information handling system 100 likewise includes system memory 112, which is interconnected to the foregoing via one or more buses 114. System memory 112 can be implemented as hardware, firmware, software, or a combination of such. System memory 112 further includes an operating system (OS) 116. Embodiments provide for the system memory 112 to include power supply management application 118, which can perform the methods described herein. Embodiments further provide for the system memory 112 to include PSU efficiency table and graphs 120.

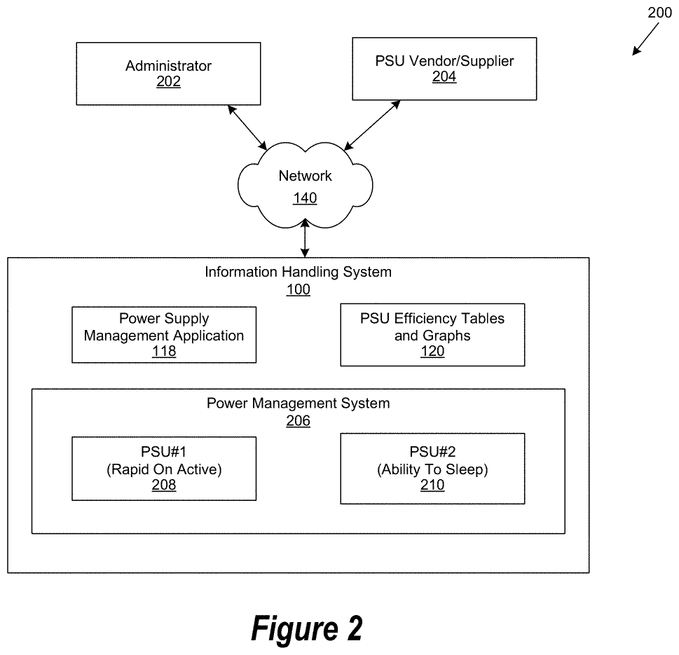

FIG. 2 shows a system for providing an active approach of selecting power supply unit operating mode. The system 200 includes the information handling system 100 as described in FIG. 1. As discussed, the information handling system 100 can be connected to a network 140 that can include one or more wired and wireless networks, including the Internet. The information handling system 100 through the network 140 can be connected to various data sources and sites, such as an administrator 202 and PSU vendor/supplier sites 204.

As discussed, implementations provide for information handling system 100 to include a power supply management application 118 and PSU efficiency tables and graphs 120. In various implementations, the PSU efficiency tables and graphs 120 are received from external sources, such as administrator 202 and PSU vendor/supplier sites 204. For example, particular supplied PSU have predetermined PSU efficiency tables and graphs 120. In certain implementations, considering that the efficiency of PSUs can be degraded over time and usage, PSU efficiency tables and graphs 120 may be generated based on actually use data of the particular PSUs of the information handling system 100.

Embodiments provide for the information handling system to include a power management system 206, which may be controlled by the power supply management application 118. Implementations provide for a “rapid on” feature, where the power management system 206 includes at least a 1 plus 1 PSU configuration. In other words, there is a minimum of at least two PSUs. It is to be understood that other configurations and implementations may provide for more than two PSUs.

In various implementations, such as the 1 plus 1 PSU configuration, a PSU is designated as “rapid on active”, as represented by PSU#1 (Rapid On Active) 208. The other PSU is designated as “ability to sleep”, as represented by PSU#2 (Ability To Sleep) 210.

Implementations provide for the PSU#1 208 to remain active and provide load to the information handling system 100, during normal modes of operation. During such operations, the PSU#2 210 can come in and out of “sleep” state depending on the output load as a percentage of the total output capacity of PSU#1 208.

Each of the PSUs (i.e., PSU#1 208 and PSU#2 210), regardless of the “rapid on” condition is configured to provide for the main voltage rail and output voltage do not fall out of limit for a designated voltage operating window of the information handling system 100.

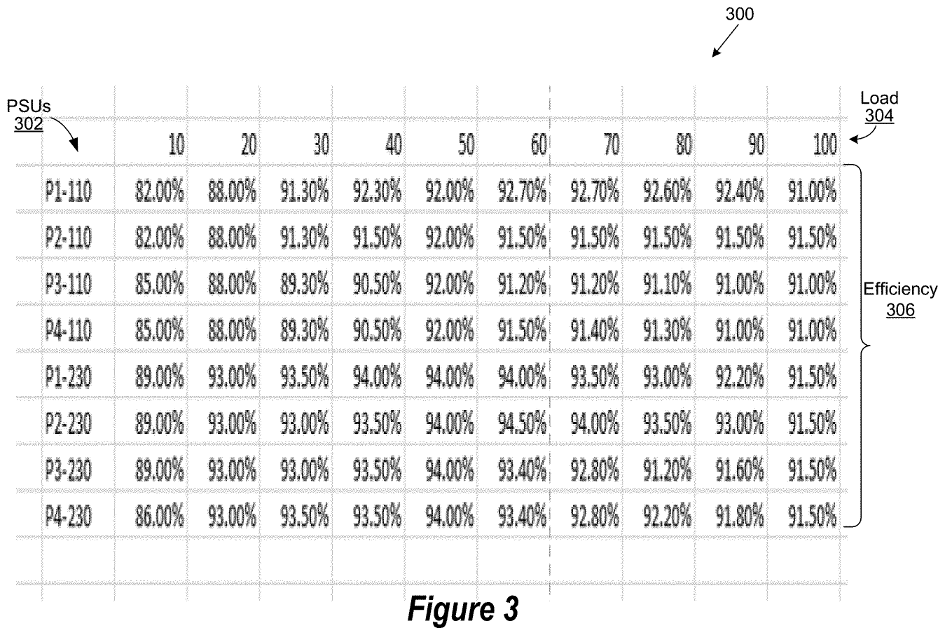

FIG. 3 shows an example of a PSU efficiency table. The PSU efficiency table 300 can be part of the PSU efficiency tables and graphs 120. PSU efficiency table 300 plots PSUs 302 versus load 304. PSUs 302 lists four particular PSUs: P1, P2, P3 and P4. The four PSUs may be operating at either 110 volts or 230 volts, as designated for example by “P1-110” which indicates PSU P1 operating at 110 volts, and “P1-230” which indicates PSU P1 operating at 230 volts.

Each PSU operating at particular voltages at particular loads has specific efficiency values shown in PSU efficiency table 300. Data in PSU efficiency table 300 can be received as described above from various sources and/or from actual PSU use data. There are minimum and maximum efficiency values. For example. P1-110 shows maximum efficiency at load percentage of 60 and 70 with a value of 92.70%. A minimum efficiency is seen at load percentage of 10 with a value of 82%.

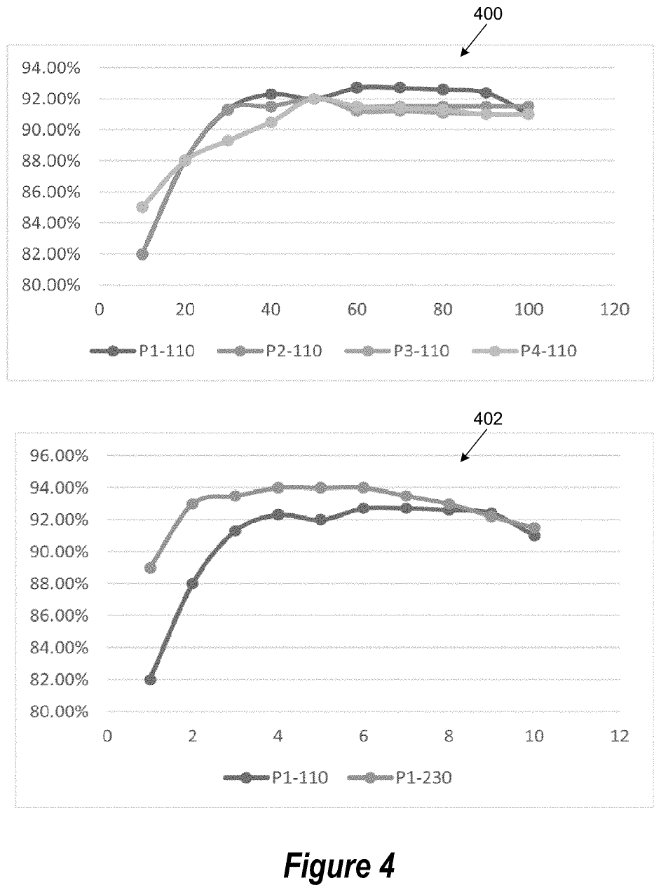

FIG. 4 shows example power supply unit efficiency graphs. The PSU efficiency graphs 400 and 402 can be part of the PSU efficiency tables and graphs 120. Graph 400 shows efficiency percentages plotted against operating load of four PSUs operating at 110 volts. Graph 402 shows efficiency percentages plotted against operating load of a PSU operating at 110 volts and 230 volts. Data in PSU efficiency graphs 400 and 402 can be received as described above from various sources and/or from actual PSU use data. There are minimum and maximum efficiency values shown and provided in PSU efficiency graphs 400 and 402.

Efficiency values, and particularly maximum and minimum efficiency values are used for an adaptive rapid on awake and sleep for an inactive or sleep state (e.g., PSU#2 210), based on efficiency response for various loads, capacity, and operating voltage of the active PSU (e.g., PSU#1 208).

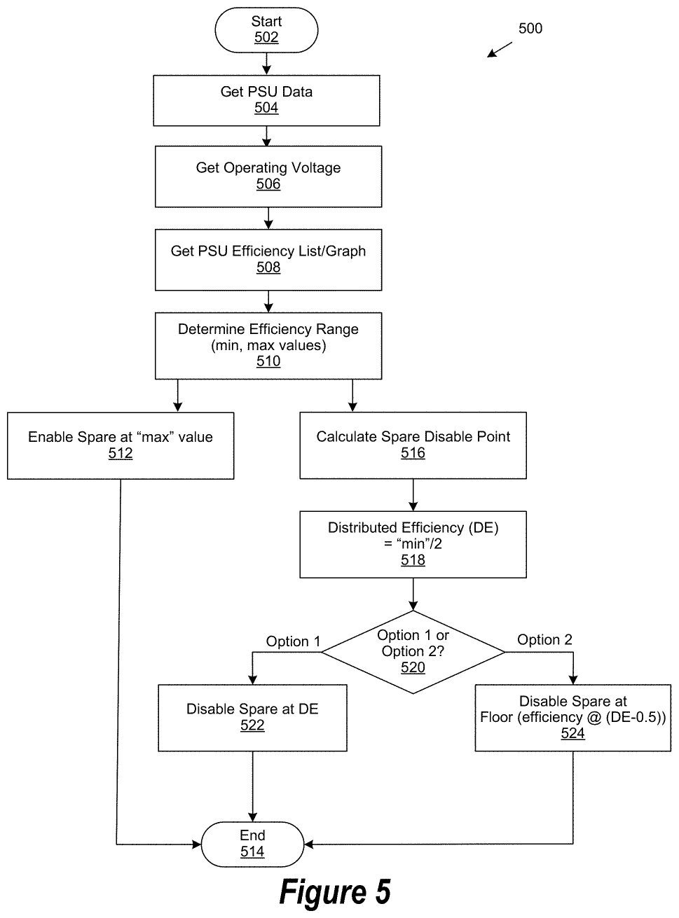

FIG. 5 shows a generalized flowchart for determining spare enabling and disabling points of power supply units. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 502, the process 500 starts. At step 504, specific PSU data is retrieved. In particular, data is retrieved as to the PSUs that are installed and operating on the information handling system. At step 506, information is retrieved regarding the voltage as to which the information handling system operates on. Such voltage is the operating voltage of the PSUs. The voltage low line and high line values can be retrieved to determine the operating voltage.

At step 508, efficiency values of the PSUs (e.g., PSU#1 208) are retrieved. The efficiency values may be in the form of efficiency tables and graphs (e.g., PSU efficiency tables and graphs 120). At step 510, a determination is performed as to efficiency range of the PSU based on operating voltage. In particular, minimum and maximum values are determined from the efficiency values in step 508.

At step 512, using the maximum value determined at step 510, the enable point is set for the spare PSU (e.g., PSU#2 210) to turn on. The enable point is the load value at which the active PSU (e.g., PSU#1 208) is most efficient. At step 514, the process 500 ends.

At step 516, the disable point is calculated as to when to turn off the spare PSU (e.g., PSU#2 210). At step 518, a distributed efficiency or DE is calculated. DE is calculated at minimum value divided by two.

At step 520, a determination is performed as to two options regarding at what load value the spare PSU (e.g., PSU#2 210) is turned. If the option 1 branch of step 520 is chosen, at step 522, the spare PSU (e.g., PSU#2 210) is turned off at a load value of the active PSU (e.g., PSU#1 208) corresponding to DE. At step 514, the process 500 ends.

If the option 2 branch of step 520 is chosen, at step 524, the spare PSU (e.g., PSU#2 210) is turned off at value corresponding to a floor(efficiency@(DE-0.5). At step 514, the process 500 ends.

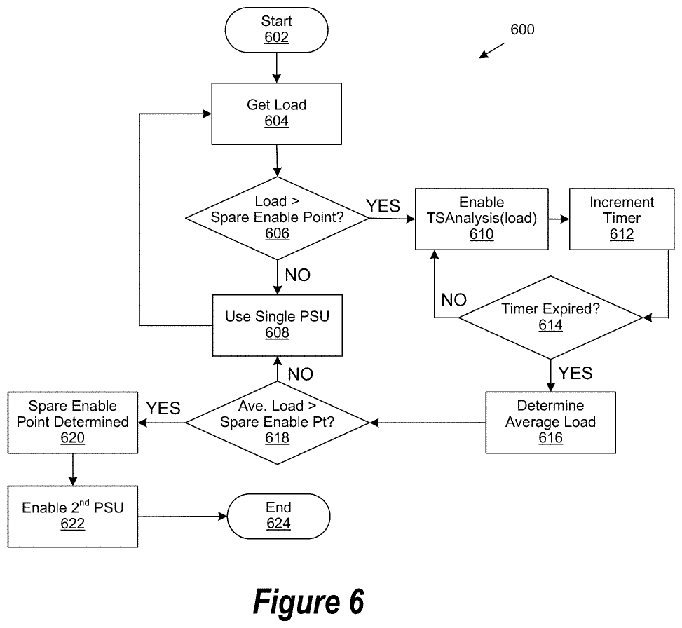

FIG. 6 shows a generalized flowchart for monitoring enabling points of power supply units. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 602, the process 600 starts. At step 604, a load in supporting an information handling system at which an active PSU (e.g., PSU#1 208) is determined. The load is an existing operating load value. If the load measured at step 606 is not greater than an enable point for the spare PSU (e.g., PSU#2 210), then following the NO branch of step 606, at step 608, a single PSU (e.g., PSU#1 208) is used, and the process 600 goes back to step 604.

If the load measured at step 606 is greater than the enable point for the spare PSU (e.g., PSU#2 210), then following the NO branch of step 606, at step 610, an enable TSAnalysis (load) function is performed. At step 612, a timer is incremented. If the timer has not expired, following the NO branch of step 614, the process 600 goes back to step 610.

If the timer has expired, following the YES branch of step 614, at step 616, determination is performed as to an average load. If the average load determined at step 616 is not greater than the enable point for the spare PSU (e.g., PSU#2 210), then following the NO branch of step 618, at step 608, a single PSU (e.g., PSU#1 208) is used, and the process 600 goes back to step 604.

If the average load determined at step 616 is greater than the enable point for the spare PSU (e.g., PSU#2 210), following the YES branch of step 618, at step 620, the enable point of the spare PSU (e.g., PSU#2 210) is determined. At step 622, the spare PSU (e.g., PSU#2 210 is enabled. At step 624, the process 600 ends.

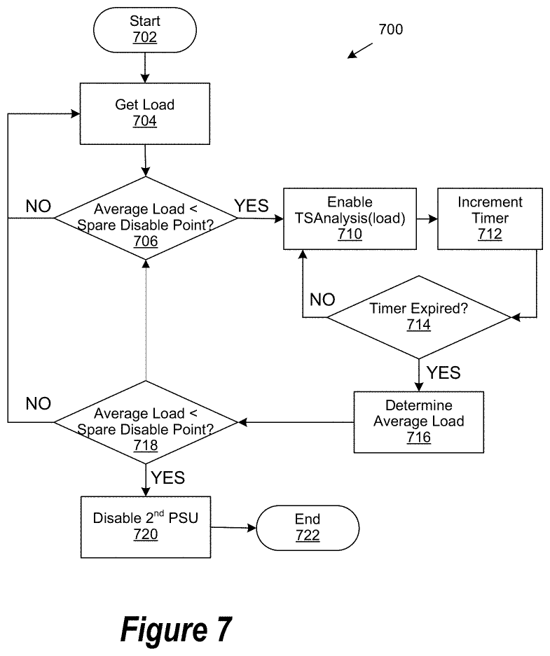

FIG. 7 shows a generalized flowchart for monitoring disabling points of power supply units. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 702, the process 700 starts. At step 704, a load in supporting an information handling system at which an active PSU (e.g., PSU#1 208) is determined. The load is an existing operating load value. If the average load, which can the average load determined at step 616 in process 600, is not less than a disable point for the spare PSU (e.g., PSU#2 210), then following the NO branch of step 706, the process 700 goes back to step 704.

If the average load is less than a disable point for the spare PSU (e.g., PSU#2 210), then following the YES branch of step 706, at step 710, enable TSAnalysis (load) function is performed. At step 712, a timer is incremented. If the timer has not expired, following the NO branch of step 714, the process 700 goes back to step 710.

If the timer has expired, following the YES branch of step 714, at step 716, determination is performed as to an average load. If the average load determined at step 716 is not less than the disable point for the spare PSU (e.g., PSU#2 210), then following the NO branch of step 718, the process 700 goes back to step 704.

If the average load determined at step 716 is less than the disable point for the spare PSU (e.g., PSU#2 210), then following the YES branch of step 718, at step 720 second or spare PSU (e.g., PSU#2 210) is disabled. At step 722, the process 700 ends.

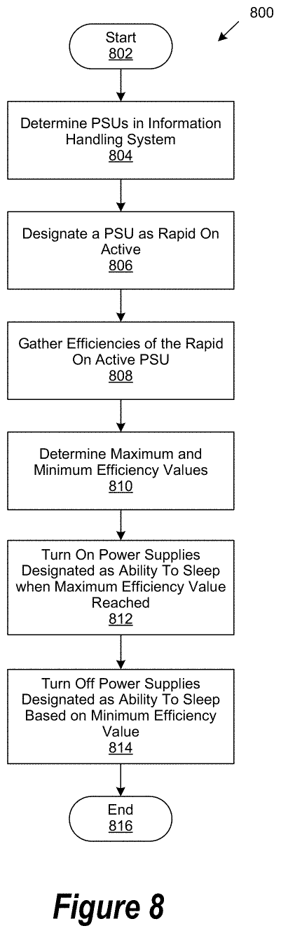

FIG. 8 is a generalized flowchart for adaptive rapid on awake and sleep for an inactive or sleep state power supply unit. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 802, the process 800 starts. At step 804, a determination is performed as to the PSUs that are part of an information handling system. The information gathered at this step can include PSU type, part number, vendor, etc.

At step 806, one of the PSUs that are determined is designated as a “rapid on active” PSU, such as the PSU#1 208 described herein.

At step 808, efficiencies of the designated “rapid on active” is gathered. As discussed, the efficiencies can be determined from efficiency tables and graphs (e.g., PSU efficiency tables and graphs 120). The efficiencies are based on operational voltage and load of the information handling system.

At step 810, using the efficiencies determined at step 808, maximum and minimum efficiency values of the “rapid on active” PSU are determined.

At step 812, PSUs designated as “ability to sleep”, such as PSU#2 210, are turned on when the maximum efficiency value of the “rapid on active” PSU is reached.

At step 814, based on minimum efficiency value of the rapid on active” PSU, the PSUs designated as “ability to sleep” are turned off. Such a value can be distributed efficiency or DE as described above, where DE is minimum efficiency value or a floor set using DE, such as floor(efficiency@(DE-0.5). At step 816, the process 800 ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

1. A computer-implementable method for active selecting power supply unit operating mode comprising:
determining power supply units (PSU) in an information handling system;
designating one of the PSU as a rapid on active PSU;
gathering efficiencies of the rapid on active PSU based on operating voltage and load of the information handling system;
determining maximum efficiency value and minimum efficiency value of the rapid on active PSU based on the gathered efficiencies;
turning on one or more PSUs designated as ability to sleep when the maximum efficiency value is reached; and
turning off the one or more PSUs designated as ability to sleep based on the minimum efficiency value.

2. The computer-implementable method of claim 1, wherein the load is a percentage of the total capacity of the rapid on active PSU.

3. The computer-implementable method of claim 1, wherein the PSUs provide for continuous main voltage and output voltage to the information handling system regardless of which PSUs are activated.

4. The computer-implementable method of claim 1, wherein the gathering efficiencies are from one or more data sources.

5. The computer-implementable method of claim 1, wherein the gathering efficiencies are from use values over time of the rapid on active PSU.

6. The computer-implementable method of claim 1, wherein the turning off is based on distributed efficiency (DE) value of the minimum efficiency value divided by two, or floor(efficiency@(DE-0.5).

7. The computer-implementable method of claim 1 further comprising monitoring enable and disable points of the one or more PSUs designated as ability to sleep.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for active selecting power supply unit operating mode and comprising instructions executable by the processor and configured for:
determining power supply units (PSU) in an information handling system;
designating one of the PSU as a rapid on active PSU;
gathering efficiencies of the rapid on active PSU based on operating voltage and load of the information handling system;
determining maximum efficiency value and minimum efficiency value of the rapid on active PSU based on the gathered efficiencies;
turning on one or more PSUs designated as ability to sleep when the maximum efficiency value is reached; and
turning off the one or more PSUs designated as ability to sleep based on the minimum efficiency value.

9. The system of claim 8, wherein the load is a percentage of the total capacity of the rapid on active PSU.

10. The system of claim 8, wherein the PSUs provide for continuous main voltage and output voltage to the information handling system regardless of which PSUs are activated.

11. The system of claim 8, wherein the gathering efficiencies are from one or more data sources.

12. The system of claim 8, wherein the gathering efficiencies are from use values over time of the rapid on active PSU.

13. The system of claim 8, wherein the turning off is based on distributed efficiency (DE) value of the minimum efficiency value divided by two, or floor(efficiency@(DE-0.5).

14. The system of claim 8 further comprising monitoring enable and disable points of the one or more PSUs designated as ability to sleep.

15. A non-transitory, computer-readable storage medium embodying computer program code, the computer program code comprising computer executable instructions configured for:
determining power supply units (PSU) in an information handling system;
designating one of the PSU as a rapid on active PSU;
gathering efficiencies of the rapid on active PSU based on operating voltage and load of the information handling system;
determining maximum efficiency value and minimum efficiency value of the rapid on active PSU based on the gathered efficiencies;
turning on one or more PSUs designated as ability to sleep when the maximum efficiency value is reached; and
turning off the one or more PSUs designated as ability to sleep based on the minimum efficiency value.

16. The non-transitory, computer-readable storage medium of claim 15, wherein the PSUs provide for continuous main voltage and output voltage to the information handling system regardless of which PSUs are activated.

17. The non-transitory, computer-readable storage medium of claim 15, wherein the gathering efficiencies are from one or more data sources.

18. The non-transitory, computer-readable storage medium of claim 15, wherein the gathering efficiencies are from use values over time of the rapid on active PSU.

19. The non-transitory, computer-readable storage medium of claim 15, wherein the turning off is based on distributed efficiency (DE) value of the minimum efficiency value divided by two, or floor(efficiency@(DE-0.5).

20. The non-transitory, computer-readable storage medium of claim 15 further comprising monitoring enable and disable points of the one or more PSUs designated as ability to sleep.
